(19) United States
(12) Patent Application Publication
(10) Pub. No.: US 2025/0068453 A1
(43) Pub. Date: Feb. 27, 2025

(54) VIRTUAL MACHINE RUNNING CONTROL METHOD, COMPUTER DEVICE, AND STORAGE MEDIUM

(71) Applicant: Beijing Volcano Engine Technology Co., Ltd., Beijing (CN)

(72) Inventor: Liang ZHOU, Beijing (CN)

(21) Appl. No.: 18/781,901

(22) Filed: Jul. 23, 2024

(30) Foreign Application Priority Data
Aug. 25, 2023 (CN) 202311085440.7

(51) Int. Cl. G06F 9/455; G06F 9/445

(52) U.S. Cl. CPC G06F 9/45558; G06F 9/4451; G06F 2009/45583; G06F 2009/45587

(57) ABSTRACT

The present disclosure provides a virtual machine running control method, a computer device, and a storage medium. The method includes: obtaining non uniform memory access NUMA node configuration information for a virtual machine, where the NUMA node configuration information is determined according to a host NUMA topological relationship corresponding to a host running the virtual machine; converting the NUMA node configuration information as target configuration information with a target format by using a virtual machine monitor, and configuring the target configuration information as a target startup parameter of a guest operating system of the virtual machine; and creating each target virtual NUMA node corresponding to the virtual machine by using the guest operating system according to the target configuration information carried in the target startup parameter.

### CROSS-REFERENCE TO RELATED APPLICATIONS

This application claims the priority of Chinese Patent Application No. 202311085440.7 filed on Aug. 25, 2023, and the disclosure of this application is incorporated by reference herein in its entirety as part of the present application.

### TECHNICAL FIELD

The present disclosure relates to a virtual machine running control method, a computer device, and a storage medium.

### BACKGROUND

In order to improve performance of service software run in a guest operating system (Guest OS) of a virtual machine, it is often possible to optimize a NUMA framework in the Guest OS, with the effect of optimization improving significantly as the specification of the virtual machine increases. In order to optimize the NUMA framework, in a common manner, a NUMA topological structure of a host running the virtual machine is transferred to the virtual machine, so that the virtual machine can optimize a NUMA framework of the virtual machine based on the NUMA topological structure of the host.

In a conventional optimization manner, the NUMA topological structure of the host is usually transferred in a manner of an advanced configuration power interface (Advanced Configuration Power Interface, ACPI) table. For example, a static resource affinity table (Static Resource Affinity Table, SRAT) and a system locality information table (System Locality Information Table, SLIT) are configured. However, because the ACPI is a complex subsystem with a huge quantity of codes and complex information, if the SRAT and the SLIT configured based on the ACPI are used to transfer the topological relationship, not only the transferring difficulty increases, but also the possibility of code intrusion increases, and a security risk is high.

### SUMMARY

Embodiments of the present disclosure at least provides a virtual machine running control method and apparatus, a computer device, and a storage medium.

An embodiment of the present disclosure provides a virtual machine running control method, including:
obtaining non uniform memory access NUMA node configuration information for a virtual machine, wherein the NUMA node configuration information is determined according to a host NUMA topological relationship corresponding to a host running the virtual machine, and the host NUMA topological relationship is used to indicate a distance between a physical central processing unit and a physical memory space in the host;
converting the NUMA node configuration information as target configuration information with a target format by using a virtual machine monitor, and configuring the target configuration information as a target startup parameter of a guest operating system of the virtual machine; and
creating each target virtual NUMA node corresponding to the virtual machine by using the guest operating system according to the target configuration information carried in the target startup parameter.

In one possible implementation, the creating each target virtual NUMA node corresponding to the virtual machine by using the guest operating system according to the target configuration information carried in the target startup parameter includes:

creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier.

In one possible implementation, the creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier includes:
adding the target memory space corresponding to the each virtual NUMA node identifier into a virtual memory manager corresponding to the virtual machine for management; and

binding each virtual central processing unit in the virtual central processing unit list corresponding to each virtual NUMA node identifier with the virtual NUMA node identifier, to obtain the target virtual NUMA node corresponding to each virtual NUMA node identifier.

In one possible implementation, the obtaining non uniform memory access NUMA node configuration information for a virtual machine includes:
determining, before the virtual machine monitor is started, a topological relationship configuration interface developed for the virtual machine monitor, and configuring the NUMA node configuration information by using the topological relationship configuration interface according to the host NUMA topological relationship; and
obtaining configured NUMA node configuration information in response to starting the virtual machine monitor.

In one possible implementation, the converting the NUMA node configuration information as target configuration information with a target format by using a virtual machine monitor includes:
determining a target memory space and a target host NUMA node that are indicated in the NUMA node configuration information by using the virtual machine monitor, wherein the target host NUMA node is one node in a plurality of host NUMA nodes included in the host NUMA topological relationship;
determining, from a total memory space corresponding to the virtual machine, a physical address range matching the target memory space; and

determining the target configuration information according to the physical address range, and the NUMA node configuration information other than the target memory space and the target host NUMA node.

In one possible implementation, the determining, from a total memory space corresponding to the virtual machine, a physical address range matching the target memory space includes:
determining a device memory space allocated to each virtual device in the virtual machine; and
determining, according to the total memory space and a device address range that corresponds to the device memory space, the physical address range matching the target memory space.

In one possible implementation, after determining a physical address range matching the target memory space, the method further includes:
binding the target memory space corresponding to the physical address range with the target host NUMA node, and binding virtual central processing units indicated in the NUMA node configuration information and physical central processing units in the target host NUMA node in pairs.

An embodiment of the present disclosure also provides a virtual machine running control apparatus, including an obtaining module, a configuration module and a creation module,
the obtaining module is configured to obtain non uniform memory access NUMA node configuration information for a virtual machine, wherein the NUMA node configuration information is determined according to a host NUMA topological relationship corresponding to a host running the virtual machine, and the host NUMA topological relationship is used to indicate a distance between a physical central processing unit and a physical memory space in the host;
the configuration module is configured to: convert the NUMA node configuration information as target configuration information with a target format by using a virtual machine monitor, and configure the target configuration information as a target startup parameter of a guest operating system of the virtual machine; and
the creation module is configured to create each target virtual NUMA node corresponding to the virtual machine by using the guest operating system according to the target configuration information carried in the target startup parameter.

An embodiment of the present disclosure also provides a computer device, including: at least one processor and at least one memory, wherein the at least one memory stores a machine-readable instruction that can be executed by the at least one processor, the at least one processor is configured to execute the machine-readable instruction stored in the at least one memory, and when the machine-readable instruction is executed by the at least one processor, the at least one processor performs the virtual machine running control method described above.

An embodiment of the present disclosure also provides a computer-readable storage medium, wherein the computer-readable storage medium stores a computer program, and when the computer program is run by a computer device, the computer device performs the virtual machine running control method described above.

For descriptions of the effect of the virtual machine running control apparatus, the computer device, and the computer-readable storage medium, refer to the descriptions of the foregoing virtual machine running control method, and details are not described herein again.

According to the virtual machine running control method and apparatus, the computer device, and the storage medium provided in embodiments of the present disclosure, after NUMA node configuration information is obtained, the node configuration information is converted into target configuration information with a target format by using a virtual machine monitor VMM, so that the NUMA node configuration information can be converted, to obtain the target configuration information that can represent a host NUMA topological relationship that needs to be transferred. In the manner of configuring the target configuration information as a target startup parameter of a guest operating system, when the guest operating system is started, each target virtual NUMA node matching the transferred host NUMA topological relationship can be created in the virtual machine by using the target configuration information in the target startup parameter, to complete transferring the host NUMA topological relationship to the virtual machine and converting the host NUMA topological relationship. In the entire transferring and conversion process of the host NUMA topological relationship, an ACPI table configured based on an ACPI does not need to be used, to achieve a light design, and reduce the transferring difficulty. In addition, large-scale codes related to the ACPI do not need to be used, and therefore, a code intrusion risk can be effectively reduced, to improve running security of the virtual machine.

In order to make the foregoing objectives, features and advantages of the present disclosure more obvious and understandable, the following provides detailed descriptions by using preferred embodiments in cooperation with the accompanying drawings.

### BRIEF DESCRIPTION OF DRAWINGS

In order to more clearly describe the technical solutions of embodiments of the present disclosure, the following briefly describes the accompanying drawings to be used in embodiments. The accompanying drawings herein are incorporated in this specification and form a part of this specification, show embodiments consistent with the present disclosure, and are used together with this specification to describe the technical solutions of the present disclosure. It should be understood that the following accompanying drawings show only some embodiments of the present disclosure, and therefore should not be regarded as limiting the scope, and a person of ordinary skill in the art may further obtain other relevant accompanying drawings from these accompanying drawings without creative efforts.

FIG. 1 is a flowchart of a virtual machine running control method according to an embodiment of the present disclosure;

FIG. 2 is a schematic diagram of a process of creating each target virtual NUMA node by using a node information conversion process according to an embodiment of the present disclosure;

FIG. 3a is a schematic diagram of a specific implementation process of a method for transferring a topological relationship in the prior art.

FIG. 3b is a schematic diagram of a specific implementation process of a virtual machine running control method according to an embodiment of the present disclosure;

FIG. 4 is a schematic diagram of a virtual machine running control apparatus according to an embodiment of the present disclosure; and

FIG. 5 is a schematic structural diagram of a computer device according to an embodiment of the present disclosure.

### DETAILED DESCRIPTION

To make the objectives, technical solutions, and advantages of embodiments of the present disclosure clearer, the following clearly and completely describes the technical solutions in embodiments of the present disclosure with reference to the accompanying drawings in embodiments of the present disclosure. Apparently, the described embodiments are merely some rather than all of the embodiments of the present disclosure. The components in embodiments of the present disclosure described and shown herein may be usually arranged and designed in a variety of different configurations. Therefore, the following detailed descriptions of embodiments of the present disclosure are not intended to limit the scope of the present disclosure for which protection is claimed, but rather represents only selected embodiments of the present disclosure. Based on embodiments of the present disclosure, all other embodiments obtained by a person skilled in the art without creative efforts fall within the protection scope of the present disclosure.

In addition, the terms “first”, “second”, and the like in the specification, the claims, and the accompanying drawings in embodiments of the present disclosure are intended to distinguish between similar objects but do not necessarily indicate a specific order or sequence. It should be understood that the data termed in such a way are interchangeable in proper circumstances, so that embodiments described herein can be implemented in other orders than the order illustrated or described herein. “A plurality of or several” mentioned in this specification means two or more than two. “And/or” describes an association relationship between associated objects, and represents that three relationships may exist. For example, A and/or B may represent the following cases: Only A exists, both A and B exist, and only B exists. The character “/” generally indicates an “or” relationship between the associated objects.

It is found through research that, to resolve a platform as a service (Platform as a Service, PaaS) security problem, a secure container scheme based on a virtualization technology is usually used. A secure container may implement isolation between containers by using an underlying hardware assisted virtualization technology, to ensure that a virtual machine in each container can independently run. A VMM and a Guest OS are usually disposed in the secure container. When there is a requirement of transferring a host NUMA topological relationship to the virtual machine, the VMM may transfer the host NUMA topological relationship to the Guest OS in a manner of configuring SRAT and SLIT tables by using an ACPI. The Guest OS may parse the SRAT and SLIT tables by using a deployed ACPI subsystem, to obtain the transferred host NUMA topological relationship, so as to create a NUMA topological relationship of the Guest OS by using the host NUMA topological relationship. However, the VMM may include a plurality of types, for example, a virtual operating system simulator qemu, a cloud management program cloud-hypervisor, and a virtualization service firecracker, and not all types of the VMM support transferring the topological relationship by using a table configured by the ACPI, and therefore, the manner has problem of poor generality. In addition, to transfer the topological relationship by using a table configured based on the ACPI, ACPI subsystems need to be deployed in both the VMM and the Guest OS. However, because the ACPI is a complex subsystem with a huge quantity of codes and complex information, if the table configured based on the ACPI is used to transfer the topological relationship, not only the transferring difficulty and code complexity increase, but also the possibility of code intrusion increases, affecting running security of the virtual machine.

Based on the foregoing research, the present disclosure provides a virtual machine running control method and apparatus, a computer device, and a storage medium. After NUMA node configuration information is obtained, the node configuration information is converted into target configuration information with a target format by using a VMM, so that the NUMA node configuration information can be converted, to obtain the target configuration information that can represent a host NUMA topological relationship that needs to be transferred. In the manner of configuring the target configuration information as a target startup parameter of a guest operating system, when the guest operating system is started, each target virtual NUMA node matching the transferred host NUMA topological relationship can be created in the virtual machine by using the target configuration information in the target startup parameter, to complete transferring the host NUMA topological relationship to the virtual machine and converting the host NUMA topological relationship. In the entire transferring and conversion process of the host NUMA topological relationship, an ACPI table configured based on an ACPI does not need to be used, to achieve a light design, and reduce the transferring difficulty. In addition, large-scale codes related to the ACPI do not need to be used, and therefore, a code intrusion risk can be effectively reduced, to improve running security of the virtual machine.

The defects that exist in the foregoing solutions are all results of the inventor's practice and careful study. Therefore, the process of discovery of the foregoing problems and the solutions proposed in the present disclosure hereinafter for the foregoing problems should be the inventor's contribution to the present disclosure in the process of the present disclosure.

It should be noted that similar reference numerals and letters indicate similar items in the following accompanying drawings, so that once an item is defined in one accompanying drawing, it does not need to be further defined and explained in subsequent accompanying drawings.

It may be understood that before the technical solutions disclosed in embodiments of the present disclosure are used, the user should be informed of the type of personal information involved in the present disclosure, the scope of use, use scenarios, and the like in a proper manner in accordance with the relevant laws and regulations, and authorization of the user should be obtained.

It should be noted that, specific nouns mentioned in embodiments of the present disclosure include:
NUMA: Non Uniform Memory Access, non uniform memory access, where a NUMA topological relationship is used to represent a distance between a central processing unit and a physical memory space.
Cmdline: a kernel startup command line parameter.
lscpu instruction: an instruction used for querying information about a CPU architecture in Linux.
numactl-hardware instruction: an instruction used for querying whether NUMA is supported in Linux, and if there are a plurality of NUMA nodes, NUMA is supported.

For ease of understanding of this embodiment, a virtual machine running control method disclosed in this embodiment of the present disclosure is first described in detail. An execution body of the virtual machine running control method provided in this embodiment of the present disclosure is usually a terminal device or another processing device that has a particular computing capability. The terminal device may be user equipment (User Equipment, UE), a mobile device, a user terminal, a terminal, a personal digital assistant (Personal Digital Assistant, PDA), a handheld device, a computer device, or the like. In some possible implementations, the virtual machine running control method may be implemented in a manner of invoking, by a processor, a computer-readable instruction stored in a memory.

The following describes, by using an example in which the execution body is a server, the virtual machine running control method provided in embodiments of the present disclosure.

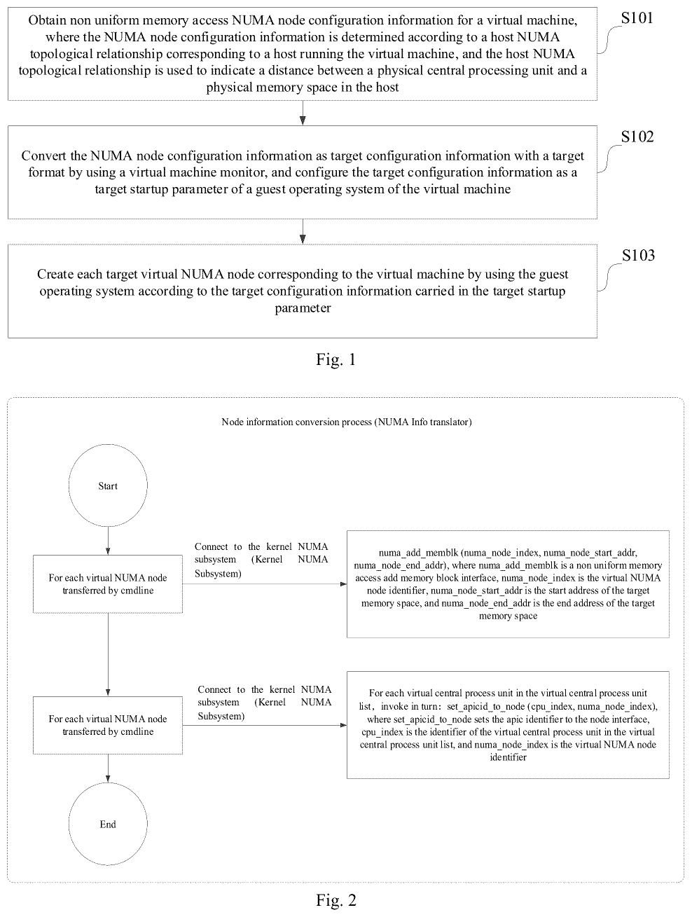

FIG. 1 is a flowchart of a virtual machine running control method according to an embodiment of the present disclosure. The method may include the following steps:
S101: Obtain non uniform memory access NUMA node configuration information for a virtual machine, where the NUMA node configuration information is determined according to a host NUMA topological relationship corresponding to a host running the virtual machine, and the host NUMA topological relationship is used to indicate a distance between a physical central processing unit and a physical memory space in the host.

Herein, the host may be a physical machine running the virtual machine. The host NUMA topological relationship may include a plurality of host NUMA nodes, and each NUMA node may include at least one physical central processing unit (Central Processing Unit, CPU) and at least one memory space. A distance between the physical CPU in each host NUMA node and the physical memory space in the NUMA node is shorter than a distance between the physical CPU in the host NUMA node and a physical memory space in a node other than the NUMA node, and a reading speed is higher.

The NUMA node configuration information may be information configured at an operation and maintenance end according to the host NUMA topological relationship, and is used to indicate node information corresponding to a virtual NUMA node that needs to be added to the virtual machine, and may specifically include information such as the newly added virtual NUMA node, a virtual central processing unit (represented as vcpu below) allocated in the virtual NUMA node, a physical memory space occupied by the virtual NUMA node, and host NUMA nodes corresponding to these memory spaces.

During specific implementation, a VMM deployed in a secure container may be used to obtain the NUMA node configuration information for the virtual machine. It should be noted that, the VMM provided in this embodiment of the present disclosure is a VMM developed by using a rust language, and using a rust-vmm based VMM indicates that, the VMM not only has all functions of a conventional VMM, but also can use an application programming interface (Application Programming Interface, API) developed for the VMM, to obtain the NUMA node configuration information.

For example, a quantity of virtual NUMA nodes that need to be added and node information of each virtual NUMA node may be determined at the operation and maintenance end according to the host NUMA topological relationship. Then, the NUMA node configuration information may be configured in a configuration format of node configuration information, and the NUMA node configuration information is sent to the rust-vmm based VMM. In this way, the NUMA node configuration information can be obtained by using the rust-vmm based VMM.

In an embodiment, S101 may be performed according to the following steps:
determining, before the virtual machine monitor is started, a topological relationship configuration interface developed for the virtual machine monitor, and configuring the NUMA node configuration information by using the topological relationship configuration interface according to the host NUMA topological relationship; and
obtaining the configured NUMA node configuration information in response to starting the virtual machine monitor.

Herein, the topological relationship configuration interface is an API pre-developed for the rust-vmm based VMM, the API is dedicated for configuring the NUMA node, and the API is valid only before the rust-vmm based VMM is started.

Therefore, during specific implementation, when a virtual NUMA node topological relationship matching the host NUMA topological relationship is created in the virtual machine, the topological relationship configuration interface developed for the rust-vmm based VMM may be first obtained, and then the topological relationship configuration interface is invoked before the rust-vmm based VMM is started. The NUMA node configuration information for the virtual machine is configured according to the host NUMA topological relationship, a quantity of newly added virtual NUMA nodes, and node information of each virtual NUMA node in the information configuration format corresponding to the topological relationship configuration interface. It should be noted that, when the topological relationship configuration interface is invoked, the topological relationship configuration interface may be used for configuring NUMA node configuration information for newly adding one virtual NUMA node at one time. If a plurality of virtual NUMA nodes need to be newly added, the topological relationship configuration interface needs to be invoked for a plurality of times, to configure a plurality of pieces of NUMA node configuration information.

The information configuration format corresponding to the topological relationship configuration interface may be shown as follows:
a newly added API (that is, the topological relationship configuration interface) indicates that one virtual NUMA node is added. If a user needs to newly add a plurality of virtual NUMA nodes, the user needs to invoke the API for a plurality of times.
add_one_numa_node (//one virtual NUMA node is added
&mut self,
id: String, //an identifier of a newly added virtual NUMA node in the rust-vmm based VMM (that is, a virtual NUMA node identifier), a character string format
size: u64, //a target memory space occupied by a newly added virtual NUMA node (that is, the target memory space), 64-bit symbol-less integer format
host_numa_node: u32, //a host NUMA node to which the memory space of the newly added virtual NUMA node needs to be bound, 32-bit symbol-less integer format
cpu_list: String //a list of vcpus allocated to the newly added virtual NUMA node (that is, the virtual central processing unit list), a character string format.

During specific implementation, after the topological relationship configuration interface is invoked, the NUMA node configuration information may be configured according to the host NUMA topological relationship in the foregoing information configuration format.

Further, after the NUMA node configuration information is configured, when the rust-vmm based VMM is started, the rust-vmm based VMM may be used to obtain each piece of NUMA node configuration information configured by using the topological relationship configuration interface. An occasion on which the rust-vmm based VMM is started may be an occasion on which the virtual machine is started.

S102: Convert the NUMA node configuration information as target configuration information with a target format by using a virtual machine monitor, and configure the target configuration information as a target startup parameter of a guest operating system of the virtual machine.

The virtual machine monitor VMM is the rust-vmm based VMM described above, and may be used to process all functions of the virtual machine in the secure container, and the core lies in ensuring secure running of the virtual machine. The target format may be a pre-specified information format, and is an information format that can be recognized and understood by the guest operating system Guest OS in the virtual machine, and the Guest OS can obtain the NUMA node configuration information based on the information format. For example, the target format may be “numa-numa_node_id, physical_start_addr@size, cpu_list_bind_to_the_node”, where numa-numa_node_id represents an identifier of the newly added virtual NUMA node in the rust-vmm based VMM, physical_start_addr@size represents a physical memory space occupied by the newly added virtual NUMA node, and cpu_list_bind_to_the_node represents a vcpu list allocated to the newly added virtual NUMA node.

The target configuration information is the NUMA node configuration information with the target format. The target startup parameter may be a cmdline parameter, and is used to transfer the target configuration information to the Guest OS.

During specific implementation, after the NUMA node configuration information is obtained, the rust-vmm based VMM may be used to perform format conversion on the NUMA node configuration information in the target format, to obtain the target configuration information. Then, the target configuration information may be injected into the cmdline of the Guest OS, to obtain the target startup parameter.

For example, the target configuration information may be: “numa-0, 0x0@0xd0000000@0x100000000@0x330000000, 0-3 numa=1, 0x430000000@0x400000000, 4-7”, where the target configuration information indicates that the NUMA topological information transferred to the Guest OS of the virtual machine includes two newly added virtual NUMA nodes:
The first NUMA node includes a vcpu 0 to a vcpu 3 (the vcpu 0, the vcpu 1, the vcpu 2, and the vcpu 3), and the NUMA node includes physical address ranges corresponding to two segments of physical memory spaces: a range 1 is (0x0) to ((0x0)+0xd0000000), and a range 2 is (0x100000000) to (0x100000000+0x330000000); and
the second NUMA node includes a vcpu 4 to a vcpu 7 (the vcpu 4, the vcpu 5, the vcpu 6, and the vcpu 7), and the NUMA node includes a physical address range corresponding to segment of a physical memory space: the range is (0x430000000) to (0x430000000+0x400000000).

In an embodiment, “converting the NUMA node configuration information as target configuration information with a target format” in S102 may be performed according to the following steps:

Step 1: Determine a target memory space and a target host NUMA node that are indicated in the NUMA node configuration information by using the virtual machine monitor, where the target host NUMA node is one node in a plurality of host NUMA nodes included in the host NUMA topological relationship.

Herein, the target memory space is the size of the physical memory space occupied by the newly added virtual NUMA node indicated by the NUMA node configuration information, and may be determined according to the size information in the NUMA node configuration information. The target host NUMA node may be any node in a plurality of host NUMA nodes included in the host NUMA topological relationship, and is also a host NUMA node to which the memory space of the newly added virtual NUMA node needs to be bound.

During specific implementation, the target memory space may be determined by using the rust-vmm based VMM according to the size information in the NUMA node configuration information, and the target host NUMA node is determined according to the host numa_node information in the NUMA node configuration information.

Step 2: Determine, from a total memory space corresponding to the virtual machine, a physical address range matching the target memory space.

Herein, the physical address range is used to indicate a start address and an end address of the target memory space.

During specific implementation, a memory space with the space size indicated by the target memory space may be filtered from the total memory space corresponding to the virtual machine, and the physical address range matching the target memory space is determined according to the start address and the end address that correspond to the memory space.

In an embodiment, the foregoing step 2 may alternatively be performed according to the following steps:
determining a device memory space allocated to each virtual device in the virtual machine; and determining, according to the total memory space and a device address range that corresponds to the device memory space, the physical address range matching the target memory space.

Herein, virtual devices may be some devices that run in the virtual machine, for example, a virtual peripheral. The device address range is a physical address range corresponding to the device memory space.

During specific implementation, the device memory space allocated to each virtual device may be determined from the total memory space corresponding to the virtual machine. Optionally, if the total memory space includes a device memory space allocated to a device such as a peripheral of the host, the device memory space may also be determined together.

After the device address range corresponding to each device memory space is determined, a to-be-adjusted physical address range with the space size indicated by the target memory space may be determined from the physical memory range corresponding to the total memory space. Then, the memory space corresponding to the device address range is filtered out from the to-be-adjusted physical address range, to obtain the physical address range corresponding to the target device space.

Alternatively, the device address range may be first filtered out from the physical memory range corresponding to the total memory space, and then the physical address range with the space size indicated by the target memory space is determined from the physical memory range from which the device address range is filtered out, and the physical address range is used as the physical address range corresponding to the target memory space.

In this way, the device address range corresponding to the device memory space is filtered out, so that the memory space occupied by a device such as a peripheral can be skipped, to shape the memory space.

Step 3: Determine the target configuration information according to the physical address range, and the NUMA node configuration information other than the target memory space and the target host NUMA node.

In this way, the NUMA node configuration information other than the target memory space and the target host NUMA node may include at least the virtual NUMA node identifier and the virtual central processing unit list.

During specific implementation, the NUMA node configuration information other than the target memory space and the target host NUMA node in the physical address range may be converted into the target configuration information in the target format.

The reason why the target host NUMA node can be removed when the target configuration information is obtained through conversion is that, after the physical address range and the target host NUMA node that match the target memory space are determined, the target memory space may be bound. Specifically, after the physical address range matching the target memory space is determined, the following step may be further performed:
binding the target memory space corresponding to the physical address range with the target host NUMA node, and binding virtual central processing units indicated in the NUMA node configuration information and physical central processing units in the target host NUMA node in pairs.

During specific implementation, the target memory space indicated by the physical address range may be bound to the target host NUMA node by using the rust-vmm based VMM, to implement NUMA binding between the memory space of the virtual machine and the memory space of the host. In addition, vcpus in the vcpu list indicated by the NUMA node configuration information may be bound to physical cpus included in the target host NUMA node in pairs. Herein, when the vcpu is bound to the physical cpu, one vcpu may be bound to any physical cpu, to implement binding in pairs. Different vcpus are bound to different physical cpus. When a quantity of vcpus is less than a quantity of physical cpus, each vcpu is bound to a physical cpu, but some physical cpus may not bound to vcpus. In this way, the vcpu of the virtual machine can be bound to the physical cpu of the host, so that the vcpu of the virtual machine and the memory space are located on a same target host NUMA node.

S103: Create each target virtual NUMA node corresponding to the virtual machine by using the guest operating system according to the target configuration information carried in the target startup parameter.

Herein, a distance relationship between each vcpu in the target virtual NUMA node and the target memory space is consistent with a distance relationship that is between a physical central processing unit and a physical memory space and that is indicated by the host NUMA topological relationship.

During specific implementation, when started, the Guest OS may obtain, from the cmdline, the target startup parameter transferred by the rust-vmm based VMM, and determine the carried target configuration information according to the target startup parameter. Then, the Guest OS may be used to create each target virtual NUMA node in the virtual machine according to the NUMA topology indicated by the target configuration information. The target virtual NUMA node is each virtual NUMA node that needs to be newly added in the virtual machine, as indicated by the NUMA node configuration information.

For example, a virtual NUMA node with the virtual NUMA node identifier carried in the target configuration information may be first created, and then each vcpu and the target memory space that are indicated by the target configuration information are added into the virtual NUMA node, to obtain the target virtual NUMA node.

In this way, after each target virtual NUMA node is created in the virtual machine, it may indicate that a NUMA topological structure the same as that of the host has been created in the virtual machine, to adjust the NUMA structure of the virtual machine. Then, when the virtual machine runs services, the vcpu and the target memory space may be invoked according to the adjusted NUMA structure, to control running of the virtual machine.

In an embodiment, S103 may be performed according to the following step:
creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier.

Herein, the node information conversion process is a pre-developed process, used to connect the NUMA topological relationship indicated by the target configuration information to the NUMA subsystem corresponding to the Guest OS without through the ACPI subsystem. The target memory space may be a memory space corresponding to the physical address range determined in the foregoing text.

During specific implementation, after the target configuration information transferred by the rust-vmm based VMM is obtained from the cmdline, the target configuration information may be parsed by using the node information conversion process, to obtain the quantity of virtual NUMA nodes, the virtual NUMA node identifier corresponding to each virtual NUMA node, and the target memory space and the virtual central processing unit list that correspond to each virtual NUMA node identifier that are indicated by the target configuration information. Then, for each virtual NUMA node identifier, the target virtual NUMA node with the identifier may be created for according to the target memory space and the virtual central processing unit list that correspond to the identifier.

In an embodiment, the target virtual node may be created by using the node information conversion process according to the following steps:
adding the target memory space corresponding to each virtual NUMA node identifier into a virtual memory manager corresponding to the virtual machine for management;
and binding each virtual central processing unit in the virtual central processing unit list corresponding to each virtual NUMA node identifier with the virtual NUMA node identifier, to obtain the target virtual NUMA node corresponding to each virtual NUMA node identifier.

During specific implementation, for each virtual NUMA node transferred from the cmdline, the node information conversion process may be used to invoke a memory management interface of the Guest OS, to add the target memory space corresponding to the virtual NUMA node identifier of the virtual NUMA node into the virtual memory manager of the virtual machine, to manage the target memory space.

For example, the memory management interface may be a non uniform memory access add memory block (numa_add_memblk) interface in the Guest OS. When the interface is invoked, the virtual NUMA node identifier and the start address and the end address of the target memory space may be disposed in the interface, to add the target memory space into the virtual memory manager. For example, an instruction for invoking the memory management interface may be “numa_add_memblk (numa_node_index, numa_node_start_addr, numa_node_end_addr)”, where numa_node_index is the virtual NUMA node identifier, numa_node_start_addr is the start address of the target memory space, and numa_node_end_addr is the end address of the target memory space.

Regardless of the quantity of virtual NUMA nodes, corresponding to which the node information is carried in the target configuration information, the node information conversion process can be used to invoke the memory management interface of the Guest OS, to manage the memory space of the newly added virtual NUMA node.

Further, after the memory space corresponding to each virtual NUMA node is added into the virtual memory manager, the node information conversion process may be further used to invoke the processor management interface of the Guest OS, to bind each virtual central processing unit in the virtual central processing unit list corresponding to each virtual NUMA node identifier with the virtual NUMA node identifier, to bind the virtual NUMA node to the vcpu, thereby obtaining each target virtual NUMA node.

For example, the processor management interface may be a set_apicid_to_node (set_apicid_to_node) interface in the Guest OS. When the interface is invoked, the virtual NUMA node identifier and the virtual central processing unit identifier may be disposed in the interface, to bind the virtual central processing unit to the target virtual NUMA node corresponding to the virtual NUMA node identifier. When the processor management interface is invoked each time, one virtual central processing unit can be bound, and therefore, when the virtual central processing unit list corresponding to the virtual NUMA node identifier includes a plurality of virtual central processing units, the processor management interface may be invoked for a plurality of times, to bind the plurality of virtual central processing units to a target virtual NUMA node corresponding to a same virtual NUMA node identifier. For example, an instruction for invoking the processor management interface may be “set_apicid_to_node (cpu_index, numa_node_index)”, where cpu_index is an identifier of a virtual central processing unit in the virtual central processing unit list, and numa_node_index is the virtual NUMA node identifier.

By invoking the foregoing two interfaces, the node information conversion process can be used to connect the host NUMA topological relationship transferred by the rust-vmm based VMM, to a kernel non uniform memory access subsystem (that is, a Kernel NUMA Subsystem), to obtain each target virtual NUMA node created in the virtual machine.

FIG. 2 is a schematic diagram of a process of creating each target virtual NUMA node by using a node information conversion process according to an embodiment of the present disclosure. For each virtual NUMA node transferred by the cmdline, the node information conversion process (that is, the NUMA Info translator in FIG. 2) can be first used to invoke the non uniform memory access add memory block (numa_add_memblk) interface, to add the target memory space corresponding to each virtual NUMA node identifier to the virtual memory manager corresponding to the virtual machine for management, and the set_apicid_to_node (set_apicid_to_node) interface is used to bind the virtual central processing unit to the target virtual NUMA node corresponding to the virtual NUMA node identifier. In this way, the host NUMA topological relationship can be connected to the kernel NUMA subsystem (Kernel NUMA Subsystem), to obtain each target virtual NUMA node created in the virtual machine.

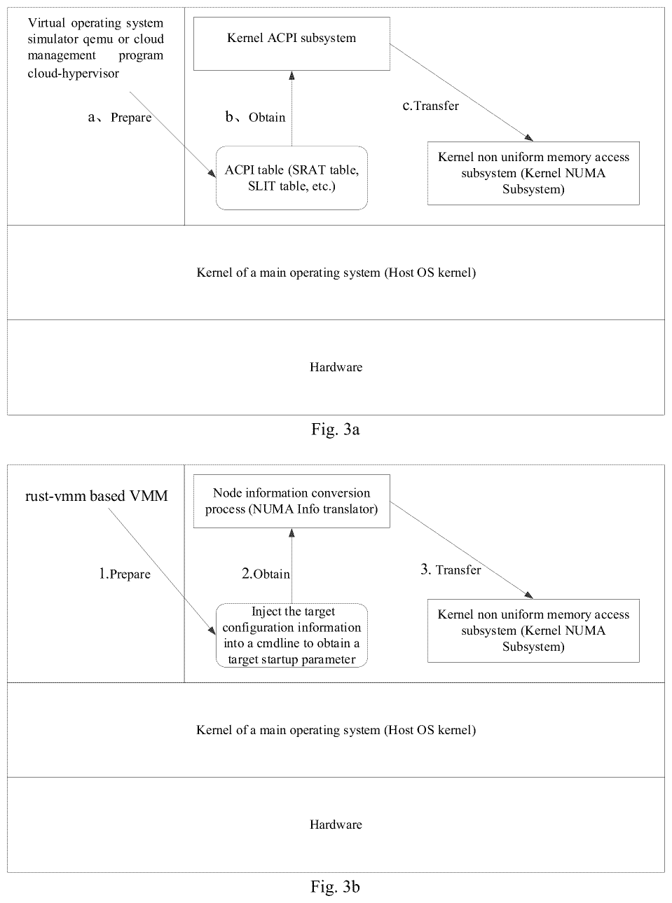

To reflect the difference between the virtual machine running control method provided in this embodiment of the present disclosure and the topological relationship transferring method in the prior art, FIG. 3a and FIG. 3b are used for intuitive reflection. FIG. 3a is a schematic diagram of a specific implementation process of a method for transferring a topological relationship in the prior art; and FIG. 3b is a schematic diagram of a specific implementation process of a virtual machine running control method according to an embodiment of the present disclosure.

In FIG. 3a, Hardware represents hardware of the host, and Host OS kernel represents a kernel of a main operating system, and the main operating system is an operating system corresponding to the host. A VMM disposed in a secure container is a virtual operating system simulator qemu or a cloud management program cloud-hypervisor. After obtaining a host NUMA topological relationship that needs to be transferred, the VMM may perform step “a. Prepare”, where the step is specifically configuring ACPI tables related to the host NUMA topological relationship, for example, a SRAT table and a SLIT table, by using an ACPI. Then, the VMM performs step “b. Obtain”, where the step is specifically obtaining, by the Guest OS, the ACPI tables, and transferring the ACPI tables to a kernel ACPI subsystem (that is, the Kernel ACPI Subsystem in FIG. 3a) of the virtual machine. It needs to be ensured that the Kernel ACPI Subsystem has been enabled. Then, the Kernel ACPI Subsystem may be used to perform step “c. Transfer”, where the step is specifically using the Kernel ACPI Subsystem to parse the ACPI tables (for example, the SRAT and SLIT tables), to obtain the transferred host NUMA topological relationship, and then transferring the NUMA topological relationship to the kernel non uniform memory access subsystem (that is, the Kernel NUMA Subsystem) of the virtual machine, so as to create the virtual NUMA node in the virtual machine.

In FIG. 3b, Hardware represents hardware of the host, and Host OS kernel represents a kernel of a main operating system, and the main operating system is an operating system corresponding to the host. A VMM disposed in a secure container is a rust-vmm based VMM. Then, a topological relationship configuration interface may be used to configure NUMA node configuration information. After obtaining the NUMA node configuration information, the rust-vmm based VMM may perform step “1. Prepare”, where the step is used to convert the NUMA node configuration information as target configuration information with a target format, and inject the target configuration information into a cmdline, to obtain a target startup parameter. After the guest operating system Guest OS of the virtual machine is started, the Guest OS may perform step “2. Obtain”, where the step is used to obtain the target configuration information carried in the target startup parameter from the cmdline, and send the target configuration information to the node information conversion process (the NUMA Info translator). Then, the NUMA Info translator may be used to perform step “3. Transfer”, where the step is used to transfer the NUMA topological information indicated by the target configuration information to the kernel non uniform memory access subsystem (that is, the Kernel NUMA Subsystem) of the virtual machine, to create each target virtual NUMA node in the virtual machine. Based on the foregoing process, the host NUMA topological relationship can be transferred to the virtual machine by using the cmdline without using the ACPI.

It can be learned based on FIG. 3a and FIG. 3b that, through comparison between the topological relationship transferring process corresponding to the topological relationship transferring method in the prior art and the topological relationship transferring process corresponding to the virtual machine running control method provided in this embodiment of the present disclosure, different VMMs are used, one uses the qemu or cloud-hypervisor, and the other uses the self-developed rust-vmm based VMM, and completely different VMMs are used. In the transferring process, one needs to use the Kernel ACPI Subsystem and the ACPI tables (for example, the SRAT and SLIT tables), and the other uses the cmdline and the NUMA Info translator, and completely different means are used. Because the cmdline and the NUMA Info translator are lighter than the Kernel ACPI Subsystem and the ACPI tables, the virtual machine running control method provided in this embodiment of the present disclosure not only can achieve a light design, and reduces the transferring difficulty, but also can effectively reduce the risk of code intrusion because there is no need to use large-scale codes related to the ACPI, to improve running security of the virtual machine.

To further reflect the topological relationship transferring effect of the virtual machine running control method provided in this embodiment of the present disclosure, some instructions in the linux operating system can be used to query the memory, the physical cpu, and the NUMA node of the host, and after the virtual machine running control method provided in this embodiment of the present disclosure is used to complete transferring of the topological relationship, the NUMA topological relationship corresponding to the virtual machine is transferred. For example, the lscpu instruction is used to query the information about the memory and the physical cpu of the host as follows:
root@xxx-xxx-xxx:˜#lscpu //xxx is used to represent specific machine information
Architecture: x86_64 //a CPU architecture is 64-bit extension of the x86 architecture
CPU op-mode(s): 32-bit, 64-bit //CPU output modes: 32 bits and 64 bits
Byte Order: Little Endian //a byte order is little endian
CPU(s): 96 //there are 96 CPUs
On-line CPU(s) list: 0-95 //an online CPU list is CPUs 0-95.
Thread(s) per core: 2 //each core has two threads
Core(s) per socket: 24 //each socket has 24 cores
Socket(s): 2 //a quantity of sockets is 2
NUMA node(s): 2 //a quantity of NUMA nodes is 2
. . . //representing some omitted information irrelevant to this application
NUMA node 0 CPU(s): 0-23, 48-71 //CPUs corresponding to the NUMA node 0 are CPUs 0-23, and CPUs 48-71
NUMA node 1 CPU(s): 24-47, 72-95 //CPUs corresponding to the NUMA node 1 are CPUs 24-47, and CPUs 72-95
. . . //representing some omitted information irrelevant to this application

The numactl instruction is used to query the information about the NUMA node of the host as follows:
root@xxx-xxx-xxx:˜#numactl --hardware
available: 2 nodes (0-1) //two NUMA nodes can be queried, that is, NUMA nodes 0 and 1
node 0 cpus: 0 1 2 3 4 5 6 7 8 9 10 11 12 13 14 15 16 17 18 19 20 21 22 23 48 49 71 //CPUs in the NUMA node 0 include CPUs 0, 1, 2, 3, 4, 5, 6, 7, 8, 9, 10, 11, 12, 13, 14, 15, 16, 17, 18, 19, 20, 21, 22, 23, 48, 49, . . . and 71
node 0 cpus: 191950 MB //a memory space size of a node 0 is 191950 MB
node 0 free: 152573 MB //a size of an idle memory space of the node 0 is 152573 MB
node 1 cpus: 24 25 26 27 28 29 30 31 32 33 34 35 36 37 38 39 40 41 42 43 44 45 47 72 . . . 95 //CPUs in the NUMA node 1 include CPUs 24, 25, 26, 27, 28, 29, 30, 31, 32, 33, 34, 35, 36, 37, 38, 39, 40, 41, 42, 43, 44, 45, 47, 72, . . . , and 95
node 1 size: 193396 MB //a memory space size of a node 1 is 193396 MB
node 1 free: 168925 MB //the size of the idle memory space of the node 1 is 168925 MB
node distances: //distances between NUMA nodes
node 0 1 //NUMA nodes 0 and 1
0:10 21 //distances between the NUMA node 0 and the NUMA node 0 and between the NUMA node 0 and the NUMA node 1 are 10 and 20
1:21 10 //distances between the NUMA node 1 and the NUMA node 0 and between the NUMA node 1 and the NUMA node 1 are 21 and 10.

After the virtual machine running control method provided in this embodiment of the present disclosure is used to complete transferring of the topological relationship, the lscpu instruction is used to query information about the memory and the vcpu of the virtual machine as follows:
root@xxx:˜#lscpu //xxx is used to represent specific machine information
Architecture: x86 64 //a vcpu architecture is 64-bit extension of the x86 architecture
CPU op-mode(s): 32-bit, 64-bit //vcpu output modes: 32 bits and 64 bits
Byte Order: Little Endian //a byte order is little endian
CPU(s): 8 //there are 96 vcpus
On-line CPU(s) list: 0-7 //an online vcpu list is vcpus 0-7
Thread(s) per core: 2 //each core has two threads
Core(s) per socket: 4 //each socket has 4 cores
Socket(s): 1 //a quantity of sockets is 1
NUMA node(s): 2 //there are two virtual NUMA nodes
. . . //representing some omitted information irrelevant to this application
NUMA node0 CPU(s): 0-3 //vcpus corresponding to the virtual NUMA node 0 are vcpus 0-3
NUMA node1 CPU(s): 4-7 //vcpus corresponding to the virtual NUMA node 1 are vcpus 4-7
. . . //representing some omitted information irrelevant to this application

The numactl instruction is used to query the information about the virtual NUMA node of the virtual machine as follows:
root@xxx:˜#numactl-hardware
available: 2 nodes (0-1) //two virtual NUMA nodes can be queried, that is, virtual NUMA nodes 0 and 1
node 0 cpus: 0 1 2 3 //vcpus in the virtual NUMA node 0 include vcpus 0, 1, 2, and 3
node 0 size: 16038 MB //a memory space size of a virtual NUMA node 0 is 16038 MB
node 0 free: 15952 MB //a size of an idle memory space of the virtual NUMA
node 0 is 15952 MB
node 1 cpus: 4 5 6 7 //vcpus in the virtual NUMA node 1 include vcpus 4, 5, 6, and 7
node 1 size: 16126 MB //a memory space size of the virtual NUMA node 1 is 16126 MB
node 1 free: 16049 MB //a size of an idle memory space of the virtual NUMA
node 1 is 16049 MB
node distances: //distances between virtual NUMA nodes
node 0 1 //virtual NUMA nodes 0 and 1
0:10 20 //distances between the virtual NUMA node 0 and the virtual NUMA node 0 and between the virtual NUMA node 0 and the virtual NUMA node 1 are 10 and 20
1:20 10 //distances between the virtual NUMA node 1 and the virtual NUMA node 0 and between the virtual NUMA node 1 and the virtual NUMA node 1 are 20 and 10.

In this way, based on the queried NUMA node information of the host and the virtual NUMA node information of the virtual machine after completing transferring of the topological relationship, it can be learned that, after the virtual machine running control method provided in this embodiment of the present disclosure is used to complete transferring of the topological relationship, the virtual NUMA topological relationship may match the host NUMA topological relationship, and therefore it may also indicate that the virtual machine running control method provided in this embodiment of the present disclosure can be used to accurately transfer the host NUMA topological relationship to the virtual machine.

In this way, based on the foregoing embodiments, in the entire transferring and conversion process of the host NUMA topological relationship, an ACPI table configured based on an ACPI does not need to be used, to achieve a light design, and reduce the transferring difficulty. In addition, large-scale codes related to the ACPI do not need to be used, and therefore, a code intrusion risk can be effectively reduced, to improve running security of the virtual machine.

A person skilled in the art may understand that, in the foregoing methods of specific implementations, the order in which the steps are written does not means a strict order of execution, and does not constitute any limitation on the implementation process, and the specific order of execution of the steps should be determined by functions and possible internal logic of the steps.

Based on a same inventive concept, an embodiment of the present disclosure further provides a virtual machine running control apparatus corresponding to the virtual machine running control method. Because the apparatus in this embodiment of the present disclosure resolves the problem in a principle similar to that of the foregoing virtual machine running control method in embodiments of the present disclosure, for the implementation of the apparatus, reference may be made to the implementation of the method, and details are not described again.

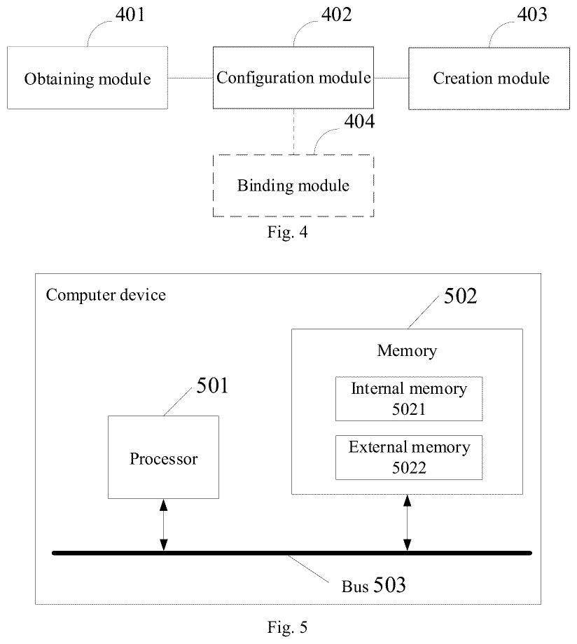

FIG. 4 is a schematic diagram of a virtual machine running control apparatus according to an embodiment of the present disclosure, including an obtaining module 401, a configuration module 402 and a creation module 403,
the obtaining module 401 is configured to obtain non uniform memory access NUMA node configuration information for a virtual machine, wherein the NUMA node configuration information is determined according to a host NUMA topological relationship corresponding to a host running the virtual machine, and the host NUMA topological relationship is used to indicate a distance between a physical central processing unit and a physical memory space in the host;
the configuration module 402 is configured to: convert the NUMA node configuration information as target configuration information with a target format by using a virtual machine monitor, and configure the target configuration information as a target startup parameter of a guest operating system of the virtual machine; and
the creation module 403 is configured to create each target virtual NUMA node corresponding to the virtual machine by using the guest operating system according to the target configuration information carried in the target startup parameter.

In one possible implementation, the creation module 403, when creating each target virtual NUMA node corresponding to the virtual machine by using the guest operating system according to the target configuration information carried in the target startup parameter, is used for:
creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier.

In one possible implementation, the creation module 403, when creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier, is used for:
adding the target memory space corresponding to the each virtual NUMA node identifier into a virtual memory manager corresponding to the virtual machine for management; and
binding each virtual central processing unit in the virtual central processing unit list corresponding to each virtual NUMA node identifier with the virtual NUMA node identifier, to obtain the target virtual NUMA node corresponding to each virtual NUMA node identifier.

In one possible implementation, the obtaining module 401, when obtaining non uniform memory access NUMA node configuration information for a virtual machine, is used for:
determining, before the virtual machine monitor is started, a topological relationship configuration interface developed for the virtual machine monitor, and configuring the NUMA node configuration information by using the topological relationship configuration interface according to the host NUMA topological relationship; and
obtaining configured NUMA node configuration information in response to starting the virtual machine monitor.

In one possible implementation, the configuration module 402, when converting the NUMA node configuration information as target configuration information with a target format by using a virtual machine monitor, is used for:
determining a target memory space and a target host NUMA node that are indicated in the NUMA node configuration information by using the virtual machine monitor, wherein the target host NUMA node is one node in a plurality of host NUMA nodes included in the host NUMA topological relationship;
determining, from a total memory space corresponding to the virtual machine, a physical address range matching the target memory space; and
determining the target configuration information according to the physical address range, and the NUMA node configuration information other than the target memory space and the target host NUMA node.

In one possible implementation, the configuration module 402, when determining, from a total memory space corresponding to the virtual machine, a physical address range matching the target memory space, is used for:
determining a device memory space allocated to each virtual device in the virtual machine; and
determining, according to the total memory space and a device address range that corresponds to the device memory space, the physical address range matching the target memory space.

In one possible implementation, the apparatus further includes a binding module 404,

The binding module 404, after determining a physical address range matching the target memory space, the method further, is used for:
binding the target memory space corresponding to the physical address range with the target host NUMA node, and binding virtual central processing units indicated in the NUMA node configuration information and physical central processing units in the target host NUMA node in pairs.

Reference may be made to related descriptions in the foregoing method embodiment for descriptions of processing procedures of the modules in the apparatus, and procedures of interactions between the modules.

Based on a same technical concept, an embodiment of this application further provides a computer device. FIG. 5 is a schematic structural diagram of a computer device according to an embodiment of this application. The computer device includes:
a processor 501, a memory 502, and a bus 503. The memory 502 stores machine-readable instructions that can be executed by the processor 501, and the processor 501 is configured to execute the machine-readable instructions stored in the memory 502. When the machine-readable instructions are executed by the processor 501, the processor 501 performs the following steps: S101: Obtain non uniform memory access NUMA node configuration information for a virtual machine, where the NUMA node configuration information is determined according to a host NUMA topological relationship corresponding to a host running the virtual machine, and the host NUMA topological relationship is used to indicate a distance between a physical central processing unit and a physical memory space in the host; S102: Convert the NUMA node configuration information as target configuration information with a target format by using a virtual machine monitor, and configure the target configuration information as a target startup parameter of a guest operating system of the virtual machine; and S103: Create each target virtual NUMA node corresponding to the virtual machine by using the guest operating system according to the target configuration information carried in the target startup parameter.

The memory 502 includes an internal memory 5021 and an external memory 5022. The internal memory 5021 herein is also referred to an inner memory, and is configured to temporarily store operational data in the processor 501, and data exchanged with the external memory 5022 such as a hard disk. The processor 501 exchanges data with the external memory 5022 by using the internal memory 5021. When the computer device runs, the processor 501 communicates with the memory 502 through the bus 503, so that the processor 501 executes the execution instruction in the foregoing method embodiment.

An embodiment of the present disclosure further provides a computer-readable storage medium, where the computer-readable storage medium stores a computer program, and when the computer program is run by a processor, the steps of the virtual machine running control method in the forgoing method embodiments are performed. The storage medium may be a volatile or non-volatile computer-readable storage medium.

A computer program product of the virtual machine running control method in this embodiment of the present disclosure includes a computer-readable storage medium storing program code, where an instruction included in the program code may be used to execute the steps of the virtual machine running control method in the foregoing method embodiment. For details, reference may be made to the foregoing method embodiment, and details are not described herein again.

The computer program product may be realized specifically by means of hardware, software or a combination thereof. In an optional embodiment, the computer program product is specifically embodied as a computer storage medium, and in another optional embodiment, the computer program product is specifically embodied as a software product, such as a software development kit (Software Development Kit, SDK) or the like.

It may be clearly understood by a person skilled in the art that, for the purpose of convenient and brief description, for a detailed working process of the system and apparatus described above, reference may be made to a corresponding process in the foregoing method embodiments. Details are not described herein again. In several embodiments provided in the present disclosure, it should be understood that the disclosed system, apparatus, and method may be implemented in another manner. The apparatus embodiments described above are merely examples. For example, division into the units is merely logic function division and may be other division in actual implementation. For another example, a plurality of units or components may be combined or integrated into another system, or some features may be ignored or not performed. In addition, the displayed or discussed mutual couplings or direct couplings or communication connections may be implemented by using some communication interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of the present disclosure may be integrated into one processing unit, each of the units may exist alone physically, or two or more units are integrated into one unit.

When the functions are implemented in the form of a software functional unit and sold or used as an independent product, the functions may be stored in a nonvolatile computer-readable storage medium that can be executed by a processor. Based on such an understanding, the technical solutions of the present disclosure essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of the present disclosure. The foregoing storage medium includes: any medium that can store program code, for example, a USB flash drive, a removable hard disk, a read-only memory (Read-Only Memory, ROM), a random access memory (Random Access Memory, RAM), a magnetic disk, or an optical disc.

If the technical solution of this application involves personal information, before the product of the technical solution of this application is applied to process the personal information, the rules for processing the personal information have been informed, and personal autonomous consent has been obtained. If the technical solution of this application involves sensitive personal information, before the product of the technical solution of this application is applied to process the sensitive personal information, personal independent consent has been obtained, and the requirement of “express consent” has been met at the same time. For example, at a personal information collection apparatus such as a camera, a clear and conspicuous sign is set up to inform that it has entered the scope of personal information collection, that personal information will be collected, and that an individual who voluntarily enters the scope of collection is deemed to have agreed to the collection of his or her personal information; or on an apparatus for processing personal information, when a clear sign or clear information is used to inform rules for processing personal information, a personal grant is obtained through pop-up information or in a manner of uploading personal information by an individual, where the rules for processing personal information may include a personal information processor, a personal information processing objective, a processing manner, a type of processed personal information, and other information.

Finally, it should be noted that the foregoing embodiments are merely specific implementations of the present disclosure, and are used to describe the technical solutions of the present disclosure, but not to limit the technical solutions of the present disclosure, and the protection scope of the present disclosure is not limited thereto. Although the present disclosure has been described in detail with reference to the foregoing embodiments, a person of ordinary skill in the art should understand that any person skilled in the art can still modify the technical solutions recorded in the foregoing embodiments, easily figure out changes, or equivalently replace some of the technical features therein within the technical scope disclosed in the present disclosure. However, these modifications, changes, or replacements do not make the essence of the corresponding technical solutions depart from the spirit and scope of the technical solutions of embodiments of the present disclosure, and should all be covered within the protection scope of the present disclosure. Therefore, the protection scope of the present disclosure shall be subject to the protection scope of the claims.

What is claimed is:

1. A virtual machine running control method, comprising:
obtaining non uniform memory access NUMA node configuration information for a virtual machine, wherein the NUMA node configuration information is determined according to a host NUMA topological relationship corresponding to a host running the virtual machine, and the host NUMA topological relationship is used to indicate a distance between a physical central processing unit and a physical memory space in the host;
converting the NUMA node configuration information as target configuration information with a target format by using a virtual machine monitor, and configuring the target configuration information as a target startup parameter of a guest operating system of the virtual machine; and
creating each target virtual NUMA node corresponding to the virtual machine by using the guest operating system according to the target configuration information carried in the target startup parameter.

2. The method according to claim 1, wherein the creating each target virtual NUMA node corresponding to the virtual machine by using the guest operating system according to the target configuration information carried in the target startup parameter comprises:
creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier.

3. The method according to claim 2, wherein the creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier comprises:
adding the target memory space corresponding to the each virtual NUMA node identifier into a virtual memory manager corresponding to the virtual machine for management; and
binding each virtual central processing unit in the virtual central processing unit list corresponding to each virtual NUMA node identifier with the virtual NUMA node identifier, to obtain the target virtual NUMA node corresponding to each virtual NUMA node identifier.

4. The method according to claim 1, wherein the obtaining non uniform memory access NUMA node configuration information for a virtual machine comprises:
determining, before the virtual machine monitor is started, a topological relationship configuration interface developed for the virtual machine monitor, and configuring the NUMA node configuration information by using the topological relationship configuration interface according to the host NUMA topological relationship; and
obtaining configured NUMA node configuration information in response to starting the virtual machine monitor.

5. The method according to claim 1, wherein the converting the NUMA node configuration information as target configuration information with a target format by using a virtual machine monitor comprises:
determining a target memory space and a target host NUMA node that are indicated in the NUMA node configuration information by using the virtual machine monitor, wherein the target host NUMA node is one node in a plurality of host NUMA nodes comprised in the host NUMA topological relationship;
determining, from a total memory space corresponding to the virtual machine, a physical address range matching the target memory space; and
determining the target configuration information according to the physical address range, and the NUMA node configuration information other than the target memory space and the target host NUMA node.

6. The method according to claim 5, wherein the determining, from a total memory space corresponding to the virtual machine, a physical address range matching the target memory space comprises:
determining a device memory space allocated to each virtual device in the virtual machine; and
determining, according to the total memory space and a device address range that corresponds to the device memory space, the physical address range matching the target memory space.

7. The method according to claim 5, wherein after determining a physical address range matching the target memory space, the method further comprises:
binding the target memory space corresponding to the physical address range with the target host NUMA node, and binding virtual central processing units indicated in the NUMA node configuration information and physical central processing units in the target host NUMA node in pairs.

8. A computer device, comprising: at least one processor and at least one memory, wherein the at least one memory stores a machine-readable instruction that can be executed by the at least one processor, the at least one processor is configured to execute the machine-readable instruction stored in the at least one memory, and when the machine-readable instruction is executed by the at least one processor, the at least one processor performs a virtual machine running control method, the method comprises:
obtaining non uniform memory access NUMA node configuration information for a virtual machine, wherein the NUMA node configuration information is determined according to a host NUMA topological relationship corresponding to a host running the virtual machine, and the host NUMA topological relationship is used to indicate a distance between a physical central processing unit and a physical memory space in the host;
converting the NUMA node configuration information as target configuration information with a target format by using a virtual machine monitor, and configuring the target configuration information as a target startup parameter of a guest operating system of the virtual machine; and
creating each target virtual NUMA node corresponding to the virtual machine by using the guest operating system according to the target configuration information carried in the target startup parameter.

9. The computer device according to claim 8, wherein the creating each target virtual NUMA node corresponding to the virtual machine by using the guest operating system according to the target configuration information carried in the target startup parameter comprises:
creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier.

10. The computer device according to claim 9, wherein the creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier comprises:
adding the target memory space corresponding to the each virtual NUMA node identifier into a virtual memory manager corresponding to the virtual machine for management; and
binding each virtual central processing unit in the virtual central processing unit list corresponding to each virtual NUMA node identifier with the virtual NUMA node identifier, to obtain the target virtual NUMA node corresponding to each virtual NUMA node identifier.

11. The computer device according to claim 8, wherein the obtaining non uniform memory access NUMA node configuration information for a virtual machine comprises:
determining, before the virtual machine monitor is started, a topological relationship configuration interface developed for the virtual machine monitor, and configuring the NUMA node configuration information by using the topological relationship configuration interface according to the host NUMA topological relationship; and
obtaining configured NUMA node configuration information in response to starting the virtual machine monitor.

12. The computer device according to claim 8, wherein the converting the NUMA node configuration information as target configuration information with a target format by using a virtual machine monitor comprises:
determining a target memory space and a target host NUMA node that are indicated in the NUMA node configuration information by using the virtual machine monitor, wherein the target host NUMA node is one node in a plurality of host NUMA nodes comprised in the host NUMA topological relationship;
determining, from a total memory space corresponding to the virtual machine, a physical address range matching the target memory space; and
determining the target configuration information according to the physical address range, and the NUMA node configuration information other than the target memory space and the target host NUMA node.

13. The computer device according to claim 12, wherein the determining, from a total memory space corresponding to the virtual machine, a physical address range matching the target memory space comprises:
determining a device memory space allocated to each virtual device in the virtual machine; and
determining, according to the total memory space and a device address range that corresponds to the device memory space, the physical address range matching the target memory space.

14. The computer device according to claim 12, wherein after determining a physical address range matching the target memory space, the method further comprises:
binding the target memory space corresponding to the physical address range with the target host NUMA node, and binding virtual central processing units indicated in the NUMA node configuration information and physical central processing units in the target host NUMA node in pairs.

15. A non-transitory computer-readable storage medium, wherein the non-transitory computer-readable storage medium stores a computer program, and when the computer program is run by a computer device, the computer device performs a virtual machine running control method, the method comprises:
obtaining non uniform memory access NUMA node configuration information for a virtual machine, wherein the NUMA node configuration information is determined according to a host NUMA topological relationship corresponding to a host running the virtual machine, and the host NUMA topological relationship is used to indicate a distance between a physical central processing unit and a physical memory space in the host;
converting the NUMA node configuration information as target configuration information with a target format by using a virtual machine monitor, and configuring the target configuration information as a target startup parameter of a guest operating system of the virtual machine; and
creating each target virtual NUMA node corresponding to the virtual machine by using the guest operating system according to the target configuration information carried in the target startup parameter.

16. The non-transitory computer-readable storage medium according to claim 15, wherein the creating each target virtual NUMA node corresponding to the virtual machine by using the guest operating system according to the target configuration information carried in the target startup parameter comprises:
creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier.

17. The non-transitory computer-readable storage medium according to claim 16, wherein the creating each target virtual NUMA node corresponding to the virtual machine by using a node information conversion process in the guest operating system according to a virtual NUMA node identifier carried in the target configuration information, and a target memory space and a virtual central processing unit list that correspond to each virtual NUMA node identifier comprises:
adding the target memory space corresponding to the each virtual NUMA node identifier into a virtual memory manager corresponding to the virtual machine for management; and
binding each virtual central processing unit in the virtual central processing unit list corresponding to each virtual NUMA node identifier with the virtual NUMA node identifier, to obtain the target virtual NUMA node corresponding to each virtual NUMA node identifier.

18. The non-transitory computer-readable storage medium according to claim 15, wherein the obtaining non uniform memory access NUMA node configuration information for a virtual machine comprises:
determining, before the virtual machine monitor is started, a topological relationship configuration interface developed for the virtual machine monitor, and configuring the NUMA node configuration information by using the topological relationship configuration interface according to the host NUMA topological relationship; and
obtaining configured NUMA node configuration information in response to starting the virtual machine monitor.

19. The non-transitory computer-readable storage medium according to claim 15, wherein the converting the NUMA node configuration information as target configuration information with a target format by using a virtual machine monitor comprises:
determining a target memory space and a target host NUMA node that are indicated in the NUMA node configuration information by using the virtual machine monitor, wherein the target host NUMA node is one node in a plurality of host NUMA nodes comprised in the host NUMA topological relationship;
determining, from a total memory space corresponding to the virtual machine, a physical address range matching the target memory space; and
determining the target configuration information according to the physical address range, and the NUMA node configuration information other than the target memory space and the target host NUMA node.

20. The non-transitory computer-readable storage medium according to claim 19, wherein the determining, from a total memory space corresponding to the virtual machine, a physical address range matching the target memory space comprises:
determining a device memory space allocated to each virtual device in the virtual machine; and
determining, according to the total memory space and a device address range that corresponds to the device memory space, the physical address range matching the target memory space.
